(19) United States
(12) Patent Application Publication
(10) Pub. No.: US 2006/0106928 A1
(43) Pub. Date: May 18, 2006

(54) Computer implemented methods and systems for decoupling execution of an action from its trigger event

(76) Inventors: Frank Westendorf, Ubstadt-Welher (DE); Michael Ihle, Forst (DE); Ralph Schnanrkowski, Frechen (DE)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/176,270

(22) Filed: Jul. 8, 2005

(30) Foreign Application Priority Data
Jul. 8, 2004 (EP) 04016083.0
Sep. 2, 2004 (EP) 04020847.2

(51) Int. Cl. G06F 15/173

(52) U.S. Cl. 709/224

(57) ABSTRACT

Systems and methods are disclosed for executing at least one action by a first server in a computer system. The action may be triggered and initiated by a predefined adjustable fulfillment level of at least one event or incident. In one implementation, a computer-implemented method is provided, the method comprising: dynamically controlling a current fulfillment level of the at least one event or incident with respect to the predefined adjustable fulfillment level using a second server, and sending, from the second server, a trigger message to the first server as soon as the current fulfillment level corresponds to the predefined fulfillment level. The method may also include initiating, in response to the trigger message, the execution of the at least one action by the first server according to a predefined execution plan object schedule.

### DESCRIPTION OF THE INVENTION

1. Field of the Invention

The present invention generally relates to the field of computer processing and the executing of actions on the basis of the content of a data object. The content of the data object may correspond to a fulfillment level of at least one event or incident. More particularly, the invention relates to computer systems and computer-implemented methods that execute at least one action in response to the content of a data object corresponding to a fulfillment level of at least one event or incident triggering the at least one action. The invention also relates to computer program products comprising computer-readable media with computer programs stored on the computer-readable media and including program coding means which are suitable for carrying out methods consistent with the invention when the computer program is run on a computer.

2. Description of Related Art

There are many areas in which actions to be executed may be controlled by a computer system by means of a computer-implemented method. For example, one of these areas is the field of commission payments, i.e., remuneration payments to employees or agents within the framework of a compensation plan. The background of the related art will now be explained with regard to the field of commission payments. However, it will be understood that the same principals can be found in other areas too, for example, shipment of goods and control of a manufacturing line.

Managing employee compensation plans has traditionally been done manually on spreadsheets or in-house developed applications. For large organizations, compensation plans may typically be complex and involve rewards like commissions, bonuses, splits, accelerators, draws, and caps. Compensation plans may therefore be difficult to maintain and manage accurately. Target agreements, also called objective agreements, play an important role in modern management in conjunction with assessment systems. Target agreements may be used within the framework of a consultation, promotion, or annual interview, in which the senior person works together with an employee or colleague to set qualitative and quantitative goals which may be looked at on a one-off basis or at regular intervals. For example, goals may be established and reviewed at yearly intervals, half-yearly intervals, or at more frequent intervals according to recent experience to check the extent to which the goals have been achieved. In the case of performance related pay, an incentive payment may be established depending on the target achieved. This principle can also be applied to agreements between clients and contractors, for example, with a contractor acting on the basis of a consultancy agreement or the like.

Computer programs exist for the computer-aided management and calculation of commission on the basis of input target amounts. In the known computer programs, the remuneration payments to an employee or agent are effected (i.e., executed) when a commission case occurs, and the occurrence of a commission case is input according to a data object which contains a description of the commission case. The commission case is an event or incident triggering a certain action, which may be a remuneration payment. After valuation of the commission case on the basis of the individual target or commission agreement and the degree to which the agreement was fulfilled, the system then triggers the payment of the commission to the employee's or agent's account. That is, known systems simply perform the steps which had previously been done on paper.

There exists a need for a more accurate commission payment system taking into account various conditions and pre-requisites which influence the flow of action in a commission payment system. For example, conventional systems fail to consider that commission payments can depend on certain release rules. A commission payment may be executed with the current release that allows time-restricted release rules and obtaining the required information from a second application.

### SUMMARY OF THE INVENTION

Consistent with embodiments of the invention, systems and methods may execute at least one action in a flexible and reliable manner. Release rules may be generated, in addition to a time-restricted condition, for at least one action to be executed. In one embodiment, a computer-implemented method is provided for executing at least one action. The method may comprise executing at least one action in response to the content of a data object corresponding to a fulfillment level of at least one event or incident triggering the at least one action. The computer-implemented method may operate such that the at least one action to be executed is decoupled from the at least one event or incident and is determined on the basis of the fulfillment level of the at least one event or incident. In case that the fulfillment level corresponds to at least one predefined variable fulfillment level, the action may be executed according to a predefined execution plan object schedule.

The at least one action to be executed may be decoupled from the at least one event or incident and determined on the basis of the fulfillment level of the event or incident. In case the fulfillment level corresponds to at least one predefined variable fulfillment level, the action may be executed according to a predefined execution plan object schedule. Individual predefined variable fulfillment levels may be generated with regard to individual conditions of the event or incident as a basis trigger of the action to be executed. In addition to a time-restricted condition, e.g., “do-not-settle-before-date-X,” further release rules, such as fulfillment levels, may be defined.

Consistent with embodiments of the invention, settlement schedule items with additional release rules may be processed in the settlement schedule run only when the release rule has been fulfilled. A complementary service may be provided, for example, the release of a partial commission after receipt of all customer payment for a specified period. Fulfillment levels may be defined as, for example, threshold values that have to be met for the settlement to be carried out. Overhead expenses such as postage or bank transfer costs for minimum amounts may thus be avoided.

In accordance with another embodiment of the invention, a method is provided for executing at least one action by a first server in a computer system, the action being triggered and initiated by a predefined adjustable fulfillment level of at least one event or incident. The method may comprise dynamically controlling a current fulfillment level of the at least one event or incident with respect to the predefined adjustable fulfillment level using a second server. The method may further comprise sending, using the second server, a trigger message to the first server as soon as the current fulfillment level corresponds to the predefined fulfillment level, and initiating, in response to the trigger message, execution of the at least one action by the first server according to a predefined execution plan object schedule.

Consistent with an embodiment of the invention, the method may further comprise dynamically storing the current fulfillment level of the at least one event or incident by means of the second server.

According to another embodiment, predefined adjustable fulfillment levels may be defined as time-dependent. The predefined adjustable fulfillment level may allude to at least one predefined part of the event or incident or may allude to a given quality of the event or incident or of at least one part of one of those.

According to still another embodiment of the invention, the incident may be chosen as a commission case and the action to be executed may be a commission payment. The commission payment may be effected on the basis of the fulfillment level of the commission case.

Consistent with a further embodiment of the present invention, computer systems may be provided for executing at least one action that may be triggered and initiated by a predefined adjustable fulfillment level of at least one event or incident. The computer system may comprise a first server including an executing plan module for generating an executing plan object on the basis of a determination of the at least one action, the executing plan object including a schedule of the execution of the at least one action, and an executing module for executing the at least one action to be executed according to the execution plan object schedule. The computer system may further comprise at least one second server including at least one database containing data objects describing the event or incident and at least one control module configured to control and store dynamically a current fulfillment level of the at least one event or incident with respect to the predefined adjustable fulfillment level. The predefined adjustable fulfillment level may include a description of release types and rules defining conditions that apply for executing the at least one action. A trigger unit may also be provided that is configured to generate and send a trigger message to the first server triggering the execution of the at least one action when the current fulfillment level corresponds to the predefined adjustable fulfillment level.

Consistent with an embodiment of the invention, the second server may be built-up of at least a first sub-server and a second sub-server, the first sub-server comprising the database means and the second sub-server comprising the control means and the trigger unit.

Consistent with an embodiment of the invention, computer programs may be provided with program coding means which are suitable for carrying out methods consistent with the invention, as described herein, when the computer program is run on a computer.

Another area in which actions to be executed may be controlled by a computer system by means of a computer-implemented method is the field of shipment of goods, to which embodiments of the present invention can also be applied. Within this field, goods may be subjected to quality control before delivery. The goods may be released for delivery when the test result corresponds to a predefined value, such as a predefined fulfillment level of quality.

Additional objects and advantages of the invention will be set forth in part in the description which follows, and in part will be obvious from the description, or may be learned by practice of embodiments of the invention. The objects and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate an embodiment of the invention and together with the description, serve to explain the principles of the invention. In the drawings:

FIG. 1 is a schematic view of an exemplary computer system, consistent with an embodiment of the invention.

### DESCRIPTION OF THE EMBODIMENTS

Reference will now be made in detail to embodiments of the invention, an example of which are illustrated in the accompanying drawing. Wherever possible, the same reference numbers will be used throughout the drawings to refer to the same or like parts.

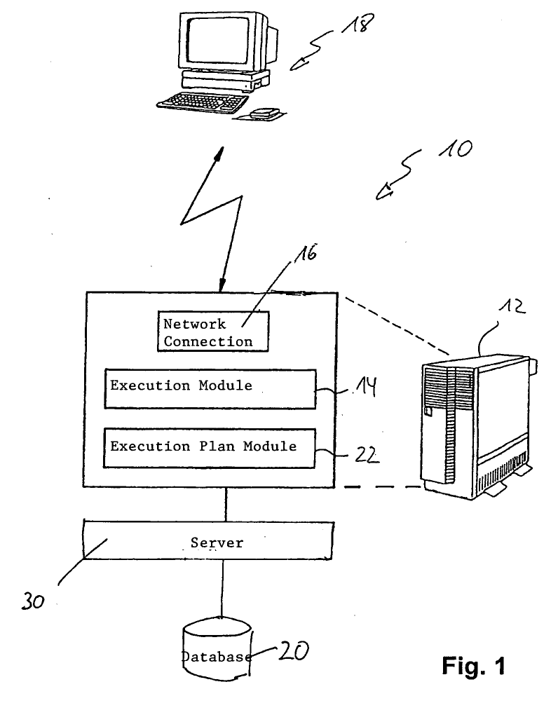

FIG. 1 shows an exemplary schematic block diagram representation, consistent with an embodiment of the present invention, of an exemplary computer system 10. Computer system 10 may execute at least one action and may include a first server or computing unit 12 with a central processing unit (CPU), a network connection 16 for connection with at least one input/output means 18, and at least one database 20 containing data objects describing an event or incident triggering at least one action to be executed. The computer scheduling system may further include an execution plan module 22 for generating an execution plan object on the basis of a determination of the at least one action, as well as an execution module 14 for executing the at least one action to be executed according to the execution plan object module. The system may further include an additional server 30, located between execution plan module 22 and database 20.

Server 30 may include means configured to control and dynamically store a current fulfillment level of the event or incident with respect to a predefined adjustable fulfillment level. Additional server 30 may contain a list providing predefined release rules. Database 20 may serve as a first sub-server, and server 30 may serve as a second sub-server. Both of these servers may be merged to one server, namely a second server.

The action to be executed by execution module 14 may only be processed when one or more release rules have been fulfilled according to the list associated with the action. Release types may be defined if the conversion of settlement schedule items should be linked to the occurrence of certain, mainly period-based events or incidents. Release types and rules may define conditions that apply for the settlement schedule item. Certain tolerance limits may also be defined for the release.

In one embodiment consistent with the invention, the action to be executed may be a remuneration payment in result of a commission case. The data objects may be commission contracts between two parties containing an individual payment plan agreement. However, it will be apparent to a person skilled in the art that the principles of the present invention are not limited to the embodiments described herein, but apply to various fields in business, commerce, industry, manufacture, and others in which an individual action may be triggered by an event (such as payment, delivery, contract fulfillment, or even accident) and in which a time schedule for executing such action is created.

Database 20 may contain, for example, a record regarding a premium due, such as monthly insurance premiums with regard to insurance policies in order to collect this from policyholders. Execution plan module 22 may contain a record with some or all of the commission-related information. Execution plan module 22 may calculate the required commissions based on this information with regard to the underlying business. If the policyholder has paid a premium, database 20 may receive the incoming payment and use functionality to determine which underlying business the premium belongs to.

A notification about the paid premium may be given to server 30, which may store and dynamically control, by means of the control means, the current fulfillment level of the premium with respect to the premium due from a specific policyholder. In case that the whole premium has been paid, server 30 may send a trigger message to execution plan module 22 to inform this module that the premium for the underlying business has been paid. If execution plan module 22 has received the external trigger or trigger message from server 30, then it may release the payment for the commission amounts which belong to the underlying business.

A release rule of a settlement schedule item may be determined by an individual agreement for settlement release, whose set of rules may be defined by a standard agreement for settlement release. Settlement schedule items with additional release rules lodged within the list of the additional server or second subserver 30 may be processed in the settlement schedule run only when the release rule has been fulfilled.

With the interconnection of additional server 30, time-restricted release rules may obtain the required information from a second application. For example, information may be obtained indicating a release of partial commission after receipt of all customer payments for a specified period. However, as noted above, the principles of the invention also apply to other fields in which an action to be taken may be triggered by an incident.

In one embodiment consistent with the invention, the incident may be a commission case and the action triggered by the commission case may be, for example, settlement of a remuneration of a given sum according to a commission contract.

Within the list provided by the additional or second sub-server 30, threshold values that have to be met for a settlement to be carried out may be defined and stored. Therefore, overhead expenses may be avoided, such a postage or bank transfer costs, for minimum amounts. The threshold values in the settlement may also be ignored.

Release types may be defined to link a conversion of settlement schedule items to the occurrence of certain, mainly period-based events. Release types and rules may define the conditions that apply for the settlement schedule item.

Standard agreements for settlement release may serve as templates for creating individual settlement release agreements in commission contracts. Each standard contract may only be assigned to one standard agreement for settlement release. Release rules may be assigned to the standard agreement and may be defaulted when the commission contracts assigned to the standard contract is processed. Additionally, fulfillment level headers may be created. Before a settlement is released, the fulfillment level information may be checked within additional server 30.

Server 30 may contain storage means to store, for example, the payment of several complete premium slices payment. In one embodiment consistent with the invention, only if the sum of the premium slices payment achieve a predefined threshold corresponding to a fulfillment level, which could be dependent on the quantity of the premium payments, as well as the total sum of paid premium in a considered period, will a commission payment be automatically released.

A period against which fulfillment notifications are cleared may be defined. Each settlement schedule item may be assigned a release status, such as “waiting for release.” If database 20 contains data objects describing an event or incident triggering the action to be executed transfers action information, server 30 may determine whether the fulfillment level is reached. Furthermore, the release status of actual commission may be required to be “released.” When both conditions are fulfilled, server 30 may provoke the commission payment to be released by execution plan module 22.

The fulfillment levels which have to be reached may depend on several different units. It may depend on a quantitative unit, for example, on a certain premium payment which have to be paid by a policyholder. Furthermore, it may be time dependent, such as a premium payment paid by a policyholder within a specific time period.

For example, different scenarios are possible for a premium per year payable in 12 monthly payments. If the premium due on a certain date is paid completely by the policyholder, then the commission due this month may be paid to the agent. This would correspond to a synchronous commission payment. Another possibility would be that the commission of the full year may be paid to the agent only if all premium payments of the year are paid by the policyholder. This can be called an asynchronous commission payment. Further, it may be defined that the commission of the full year should be paid to the agent only if the first premium payment of the year has been paid by the policyholder. This is also an asynchronous commission payment.

Another example for an asynchronous commission payment is when a commission payment is released after payment of several complete premium slices, for example, payment after achievement of a threshold. This threshold may depend on the quantity of the premium payments as well as the total sum of paid premium in a certain considered period.

Payment slices not yet triggering the commission to be released may be stored within the storage or memory of server 30 and added up successively until a predefined fulfillment level is reached, which may trigger commission to be paid to the agent. Afterwards, entries within the storage means associated with this commission payment may be erased.

Other embodiments of the invention will be apparent to those skilled in the art from consideration of the specification and practice of embodiments and features of the invention disclosed herein. It is intended, therefore, that the specification and embodiments be considered as exemplary only, with a true scope and spirit of the invention being indicated by the following claims.

What is claimed is:

1. A method for executing at least one action in response to the content of a data object corresponding to a fulfillment level of at least one event or incident triggering the at least one action, the method comprising:
decoupling the at least one action to be executed from the at least one event or incident, wherein the at least one action is determined on the basis of the fulfillment level of the at least one event or incident; and
executing, in case that the fulfillment level corresponds to at least one predefined variable fulfillment level, the action according to a predefined execution plan object schedule.

2. The method of claim 1, further comprising dynamically storing the current fulfillment level of the at least one event or incident using the second server.

3. The method of claim 1, wherein the predefined adjustable fulfillment level is time-dependent.

4. The method of claim 1, wherein the predefined adjustable fulfillment level alludes to at least one predefined part of the event or incident.

5. The method of claim 1, wherein the predefined adjustable fulfillment level alludes to a given quality of the event or incident.

6. The method of claim 1, wherein
the incident is a commission case; and
the action to be executed is a commission payment effected on the basis of the fulfillment level of the commission case.

7. A method for executing at least one action by a first server in a computer system, the action being triggered and initiated by a predefined adjustable fulfillment level of at least one event or incident, the method comprising:
dynamically controlling a current fulfillment level of the at least one event or incident with respect to the predefined adjustable fulfillment level using a second server;
sending, from the second server, a trigger message to the first server as soon as the current fulfillment level corresponds to the predefined fulfillment level; and
initiating, in response to the trigger message, the execution of the at least one action by the first server according to a predefined execution plan object schedule.

8. The method of claim 7, further comprising dynamically storing the current fulfillment level of the at least one event or incident using the second server.

9. The method of claim 7, wherein the predefined adjustable fulfillment level is time-dependent.

10. The method of claim 7, wherein the predefined adjustable fulfillment level alludes to at least one predefined part of the event or incident.

11. The method of claim 7, wherein the predefined adjustable fulfillment level alludes to a given quality of the event or incident.

12. The method of claim 7, wherein
the incident is a commission case; and
the action to be executed is a commission payment effected on the basis of the fulfillment level of the commission case.

13. A computer system for executing at least one action triggered and initiated by a predefined adjustable fulfillment level of at least one event or incident, comprising:
a first server, comprising:
an executing plan module for generating an executing plan object on the basis of a determination of the at least one action, the executing plan object including a schedule of the executing of the at least one action, and
an executing module for executing the at least one action to be executed according to the executing plan object schedule; and
at least one second server, comprising:
at least one database containing data objects describing the event or incident;
at least one control module configured to control and dynamically store a current fulfillment level of the at least one event or incident with respect to the predefined adjustable fulfillment level containing a description of release types and rules defining conditions that apply for executing the at least one action; and
a trigger unit configured to generate and send a trigger message to the first server to trigger the execution of the at least one action when the current fulfillment level corresponds to the predefined adjustable fulfillment level.

14. The computer system of claim 13, wherein the second server is built-up of at least a first sub-server and a second sub-server, the first sub-server comprising the database and the second sub-server comprising the control module and the trigger unit.

15. A computer readable medium comprising program code instructions which, when executed in a processor, perform a method for executing at least one action in response to the content of a data object corresponding to a fulfillment level of at least one event or incident triggering the at least one action processing data, the method comprising:
decoupling the at least one action to be executed from the at least one event or incident, wherein the at least one action is determined on the basis of the fulfillment level of the at least one event or incident; and
executing, in case that the fulfillment level corresponds to at least one predefined variable fulfillment level, the action according to a predefined execution plan object schedule.

16. A computer readable medium comprising program code instructions which, when executed in a processor, perform a method for executing at least one action by a first server in a computer system, the action being triggered and initiated by a predefined adjustable fulfillment level of at least one event or incident, the method comprising:
dynamically controlling a current fulfillment level of the at least one event or incident with respect to the predefined adjustable fulfillment level using a second server;
sending, from the second server, a trigger message to the first server as soon as the current fulfillment level corresponds to the predefined fulfillment level; and
initiating, in response to the trigger message, the execution of the at least one action by the first server according to a predefined execution plan object schedule.
